(19) United States
(12) Patent Application Publication
(10) Pub. No.: US 2024/0214477 A1
(43) Pub. Date: Jun. 27, 2024

(54) NETWORK BASED MEASUREMENT SYSTEM

(71) Applicant: Endress+Hauser Conducta GmbH+Co. KG, Gerlingen (DE)

(72) Inventors: Roman Griesser, Gerlingen (DE); Marco Bezzon, Stuttgart (DE); Nikolai-Sven Strohfeldt, Stuttgart (DE); Bernhard Riester, Stuttgart (DE); Maurice Güttler, Karlsruhe (DE)

(21) Appl. No.: 18/390,163

(22) Filed: Dec. 20, 2023

(30) Foreign Application Priority Data
Dec. 22, 2022 (DE) 10 2022 134 606.4

(51) Int. Cl. H04L 69/323

(52) U.S. Cl. CPC H04L 69/323

(57) ABSTRACT

The present disclosure discloses a network-based measuring system, including a first sensor, at least one second sensor, and at least one intermediate unit, wherein the first and/or second sensor are electrically connected to the intermediate unit via a connection. The first and second sensors are supplied with power via the connection and data is exchanged bidirectionally. The connection comprises a network-based protocol, wherein the intermediate unit is connected to a higher-level unit, wherein the first and second sensors exchange data with one another without knowledge of the higher-level unit.

### CROSS-REFERENCE TO RELATED APPLICATION

The present application is related to and claims the priority benefit of German Patent Application No. 10 2022 134 606.4, filed on Dec. 22, 2022, the entire contents of which are incorporated herein by reference.

### TECHNICAL FIELD

The present disclosure relates to a network-based measuring system.

### BACKGROUND

The world's dominant transmission technology for process control and safety connectivity of field devices in the process industry is analog 4-20 mA technology.

The first experiences with the PROFIBUS PA and Foundation Fieldbus field buses, which were developed for the process industry, were made around the turn of the millennium. The use of field bus technology offers cost and application advantages over 4-20 mA technology. Significant advantages include reduced wiring effort, higher signal quality due to digitization, faster start-up, higher information transmission and remote control. However, as the technology was introduced, these faded into the background. Initial technical difficulties caused by defective device implementation and the lack of application experience on the operator side have contributed significantly to the problems encountered during the rollout of the technology.

The “classic” measuring system comprises a sensor that is connected to a transmitter (often also referred to as a measuring transducer). In analysis applications, for example in the case of a pH sensor, the sensor is connected to the transmitter via a cable. The transmitter then connects to a higher-level unit, for example a control system, via the above-mentioned 4-20 mA interface or a field bus.

Even today, field bus technology is often perceived as too complex. However, two substantial problems arise. One is the mapping of field bus functionality to the control and regulation system, and the other is the lack of ability and willingness to train and educate operating personnel. Since then, the technology has evolved, for example with the introduction of new device profiles that allow for easier handling in control and regulation systems. While the use of field bus solutions is common in other areas of automation (e.g. factory automation, building automation), the use of field buses in process automation is still rare.

Information technology (IT) refers to electronic data processing and the operational technology (OT) hardware and software infrastructure used for it, through the direct monitoring and/or control of industrial plants, assets, processes, and events. In the past, IT and OT were separate domains. Today, the IT/OT infrastructure, from field devices to controllers, is built separately from the infrastructure required for process control. The physical separation of the two systems increases the diversity and independence of hardware and software, which in turn increases availability. However, maintaining two independent technologies increases the overall effort, for example in terms of storage and training.

### SUMMARY

The present disclosure is based on the object of providing a safe and easy-to-operate infrastructure for process automation sensors.

The object is achieved by a network-based measuring system comprising a first sensor, at least one second sensor, and at least one intermediate unit, wherein the first and/or second sensor are electrically connected to the intermediate unit via a connection, wherein the first and second sensor are supplied with power via the connection and data is exchanged bidirectionally, wherein the connection comprises a network-based protocol, in particular with TCP/IP protocol, wherein the intermediate unit is connected to a higher-level unit, wherein the first and second sensors exchange data with one another without knowledge of the higher-level unit.

The sensors thus communicate directly via a network-based protocol, for example Ethernet over APL or SPE (see below), and the measuring system forms a network, for example consisting of APL/SPE sensors, which are then connected to a higher-level unit (for example a control center or PLC). All network subscribers can also communicate with one another.

The result is thus a fully flexible system that can be continuously expanded with new subscribers. This topology fulfills all the application scenarios of the past. The sensors can be operated independently, and “classic” transmitters are no longer required. If sensors require external measured values for measurement (for example, a pH compensation is required for chlorine measurement), the first sensor can retrieve the measured value directly from the second sensor via the network. A “coordinator” (i.e., transmitter) is no longer necessary.

The initial configuration takes place via a higher-level unit (for example a control center or a PLC) or a control panel (see below).

One embodiment provides for the network-based protocol to comprise the Ethernet Advanced Physical Layer as the physical layer.

One embodiment provides for the network-based protocol to comprise a standard according to IEC 63171-7, in particular Single Pair Ethernet.

One embodiment provides for the network-based protocol to be configured as a wireless protocol, in particular according to an IEEE 802.11 standard.

One embodiment provides for the first and/or second sensor to comprise an external power supply.

One embodiment provides for the first and/or second sensor to be an ion-sensitive sensor, in particular a pH sensor, conductivity sensor, turbidity sensor, temperature sensor, oxygen sensor, a sensor for measuring the absorption of electromagnetic waves in the medium, for example with wavelengths in the UV, IR, and/or visible range, a sensor for measuring the concentration of metallic or non-metallic substances, flow sensor, pressure sensor, or fill-level sensor.

One embodiment provides for the first and second sensors to be configured independently, i.e., the sensor in particular supplies its measured value, i.e., number value and unit.

One embodiment provides for the measuring system to comprise a control panel that is connected to a sensor or is connected to the intermediate unit or is part of the intermediate unit, and wherein the first and second sensors and the control panel exchange data with one another without knowledge of the higher-level unit.

One embodiment provides for the control panel to be connected to the higher-level unit via a network-based protocol, in particular Ethernet, Ethernet-APL, or Ethernet SPE.

One embodiment provides for the control panel to be connected to the higher-level unit via a non-network-based protocol, in particular HART, WirelessHART, Modbus, PROFIBUS, Foundation Fieldbus, IO-Link, Bluetooth or RFID.

One embodiment provides for the intermediate unit to be configured as a switch.

One embodiment provides for the second sensor to retrieve measurement data from the first sensor.

One embodiment provides for the measuring system to comprise a non-sensor unit, for example a cleaning unit, that is connected to the network-based protocol, in particular via the intermediate unit or directly to the sensor.

One embodiment provides for the first sensor, the second sensor, the switch and/or the control panel to be configured as explosion-proof devices.

### BRIEF DESCRIPTION OF THE DRAWINGS

This is explained in more detail with reference to the following figures.

FIG. 1 shows a measuring system;

FIG. 2 shows the claimed measuring system;

FIG. 3 shows the claimed measuring system with a control panel;

FIG. 4 shows the claimed measuring system in the explosion-endangered area;

FIG. 5 shows the claimed measuring system in one embodiment; and

FIG. 6 shows the claimed measuring system with a control panel with an integrated switch.

In the figures, the same features are labeled with the same reference signs.

### DETAILED DESCRIPTION

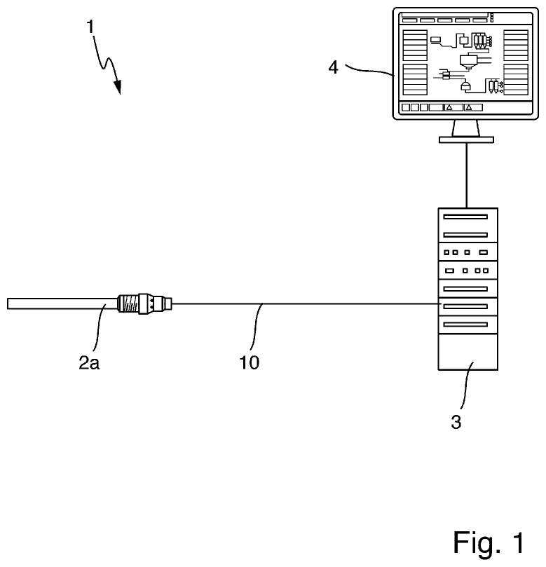

FIG. 1 shows a measuring system 1 having a sensor 2a. The sensor 2a, as well as the other sensors 2b-f (see below) is, for example, an ion-sensitive sensor, in particular a pH sensor, conductivity sensor, turbidity sensor, temperature sensor, oxygen sensor, a sensor for measuring the absorption of electromagnetic waves in the medium, for example with wavelengths in the UV, IR, and/or visible range, or a sensor for measuring the concentration of metallic or non-metallic substances. Other embodiments of the sensor 2a are possible, for example a pressure sensor, fill-level sensor or flow sensor. The sensor 2a-f serves to determine a measurand. For this purpose, the sensor usually comprises at least one sensor element for detecting a measurand of process automation. The sensor 2a-f is thereby placed in the medium to be measured with the sensor element. If a plurality of sensors are mapped, they can be configured identically or differently.

The sensor 2a-f in each case comprises a data processing unit, for example a microcontroller, in any case an intelligent unit. For this purpose, the sensor 2a-f is able to provide not only raw values, for example in voltage units (volts) or current units (amperes), as an output value. Instead, the sensor 2a-f can directly provide the corresponding measurand as a measured value as an output value; a pH sensor thus directly provides the pH, a conductivity sensor the conductivity, etc. For this purpose, the sensor 2a-f provides not only the number value as such, but also the corresponding physical unit, for example Siemens in the case of conductivity. The sensor 2a-f can also transmit the corresponding measured value automatically (i.e., together with the unit) and not only on request. The sensor 2a-f is thus as such independent from the surroundings, such as independent from any measuring transducers, transmitters or higher-level units.

The sensor 2a is connected directly to a higher-level unit 3 via a network-based protocol 10. The higher-level unit 3 is, for example, a control system, control room, a programmable logic controller (PLC) or the like. Using the higher-level unit 3, the sensor 2a can optionally be operated, configured and parameterized via an operating unit 4. The entire measuring system 1 can be controlled or operated via the higher-level unit 3.

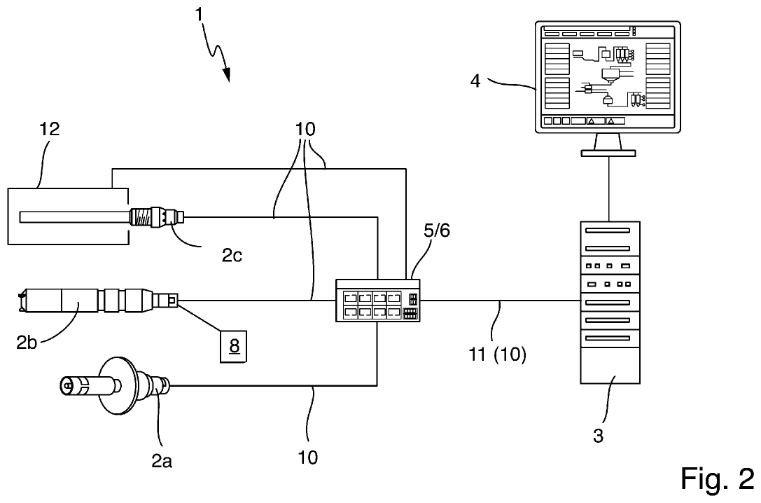

One embodiment of the claimed measuring system 1 is shown in FIG. 2. The measuring system 1 comprises at least one first sensor 2a and a second sensor 2b, in this case also a third sensor 2c. The sensors are configured as described above. The sensors 2a, 2b, 2c are connected to an intermediate unit 5 via a network-based protocol 10. In this case, the intermediate unit 5 is configured as a switch 6. The intermediate unit 5 is connected to the higher-level unit 3, for example, via a non-network-based protocol 11 (HART, WirelessHART, Modbus, PROFIBUS, Foundation Fieldbus, IO-Link, Bluetooth or RFID). Said higher-level unit is in turn connected to the operating unit 4. The intermediate unit 5 can also be connected to the higher-level unit 3 via a network-based protocol, for example Ethernet-APL. This is indicated by the reference sign “10” in brackets in FIG. 2 and also in the other figures. The connection of the higher-level unit 3 to the switch connected thereto depends on the technology. There are thus corresponding switches, for example an Ethernet-APL switch, Ethernet SPE switch, etc., which can also be integrated into the switch or the control panel (see below); a first protocol can be transferred to a second, for example to HART, Modbus, PROFIBUS, Foundation Fieldbus.

The network-based protocol 10 comprises a TCP/IP protocol. The network-based protocol 10 comprises the Ethernet Advanced Physical Layer (Ethernet-APL) as the physical layer. A “physical layer” is to be understood here according to the ISO/OSI reference model (Open Systems Interconnection model) and is a reference model for network protocols as a layered architecture. This is thus the layer 1, i.e., the “physical layer,” which is sometimes referred to as the “bit transfer layer.”

Ethernet-APL is a special 2-wire Ethernet based on 10BASE-T1L according to IEEE 802.3cg. The Ethernet-APL communication is thus part of, and fully compatible with, the IEEE 802.3 Ethernet specification. The transfer takes place at a data transfer rate of 10 Mbps, is 4B3T coded and modulated as PAM-3 and transferred full-duplex at 7.5 MBaud. The sensors 2a-f are supplied with power via the connection 10, and data is exchanged bidirectionally. For example, measurement data is transferred, or configuration data is exchanged.

The sensors 2a-f are thus connected in a star-shaped manner.

The use of the network-based protocol 10 has, inter alia, the advantage that the sensors 2a-f can communicate directly with one another. A switch or the path through a measuring transducer, transmitter or a higher-level unit 3 is not necessary. For example, a temperature sensor can communicate directly with a pH sensor or conductivity sensor, and the pH sensor/conductivity sensor can use this temperature value to calculate the corresponding measured value (pH or conductivity). A further example is the direct communication of a pH sensor with a chlorine or disinfection sensor.

Flexible expansion of the measuring system 1 is possible without difficulty. At the beginning, a sensor 2a-f or a non-sensor unit 12 (see below) is connected to the network 10 via a control panel 7 (see below), the higher-level unit 3, a data processing unit connected to the network 10, for example a PC, or otherwise. This is merely a first step and is only required once. From this point in time, the sensors 2a-f can communicate with one another without knowledge of the higher-level unit 3.

In one embodiment, the protocol comprises a standard according to IEC 63171-7, in particular Single Pair Ethernet (SPE).

In one embodiment, the protocol is configured as a wireless protocol, in particular according to an IEEE 802.11 standard, i.e., Wi-Fi or WLAN.

Some network-based protocols 10 combine communication and supply, such as Ethernet-APL or SPE. Power over Ethernet (PoE) is also possible.

The sensor 2a-f can be supplied with power via an external power supply 8 if the power supplied via the network-based protocol 10 is insufficient or cannot be supplied at all, for example in the embodiment of the protocol 10 as a wireless protocol. This is the case for sensor 2b in FIG. 2 and indicated symbolically.

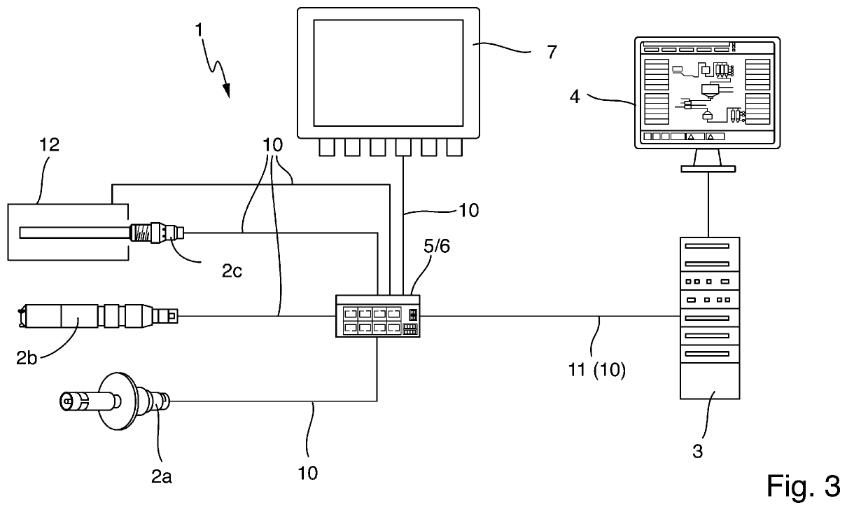

FIG. 3 shows an embodiment. The sensors 2a, 2b, 2c are connected to an intermediate unit 5 via a network-based protocol 10. This is configured as a switch 6. A control panel 7 is connected to the switch 6. The control panel 7 can communicate with the sensors 2a, 2b, 2c or a single sensor independently of the higher-level unit 3. The control panel 7 can have additional functions and inputs/outputs, relays or controllers. Likewise, a switch and/or gateway for other protocols can be integrated into the control panel (see below). Compared to a “classic” measuring system having a transmitter as described above, the control panel 7 as such is completely optional, and is only used as an optional operating option (in-situ).

However, the control panel 7 can also be configured as a transmitter, i.e., a transmitter is configured as a control panel with the possibility of communicating via network-based protocols. If the transmitter is used in the “classic” way, the configuration and parameterization of the sensor 2a, 2b, 2c can take place via the transmitter. Optionally, however, this is also done via the higher-level unit 3 or via web-based methods, such as web servers that are installed on the transmitter or the higher-level unit 3. The embodiment described in this section is not preferred within the scope of the present application but is possible in principle.

The intermediate unit 5/6 is connected to the control panel 7 via a non-network-based protocol 11 (HART, WirelessHART, Modbus, PROFIBUS, Foundation Fieldbus, IO-Link, Bluetooth, RFID) or via a network-based protocol 10 (Ethernet—“classic,” APL, or SPE). In the embodiment in FIG. 3, the switch 6 is connected to the higher-level unit 3 via Ethernet 10 (the embodiment with the non-network-based protocol 11 is accordingly shown in brackets).

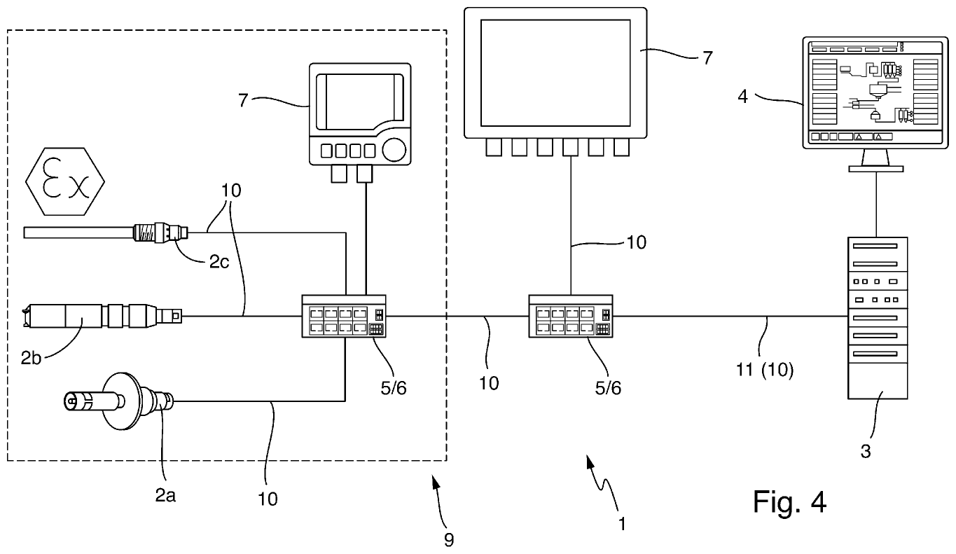

FIG. 4 shows an embodiment. The sensors 2a, 2b, 2c are located in the explosion-endangered area 9, as is the intermediate unit 5, which is configured as a switch 6. A control panel 7 is connected thereto. This is an optional control panel in the explosion-endangered area 9. These communicate or are supplied with power via the network-based protocol 10.

In this case, “explosion-proof” refers to intrinsic safety as a technical property of a device or system that, due to special design principles, ensures that no unsafe state occurs even in the event of a fault. This can be achieved by predetermined breaking points, special current sources or other measures, so that a dangerous situation cannot arise. The fault event describes situations where there is a risk. For example, the possibility of spark formation when closing an electrical circuit is associated with risks only in explosion-endangered areas. Intrinsic safety is an essential requirement for the global process industry, which requires a solution that is easy to implement for controlling and supplying power to field devices in explosion-endangered areas.

The intermediate unit 5/6 from the explosion-endangered area 9 is connected to a further intermediate unit 5 in the non-explosion-endangered area via the network-based protocol 10. The network-based protocol 10 is also explosion-proof. The intermediate unit 5 in the non-explosion-endangered area is configured as a switch 6 and a gateway. This intermediate unit 5 is thus an intermediary between the network-based protocol 10 and units 3 connected thereto (for example a higher-level unit) and a further control panel 7 (optional control panel in the non-explosion-endangered area), which are connected here via Ethernet 10 (“classic”, but also as APL or SPE).

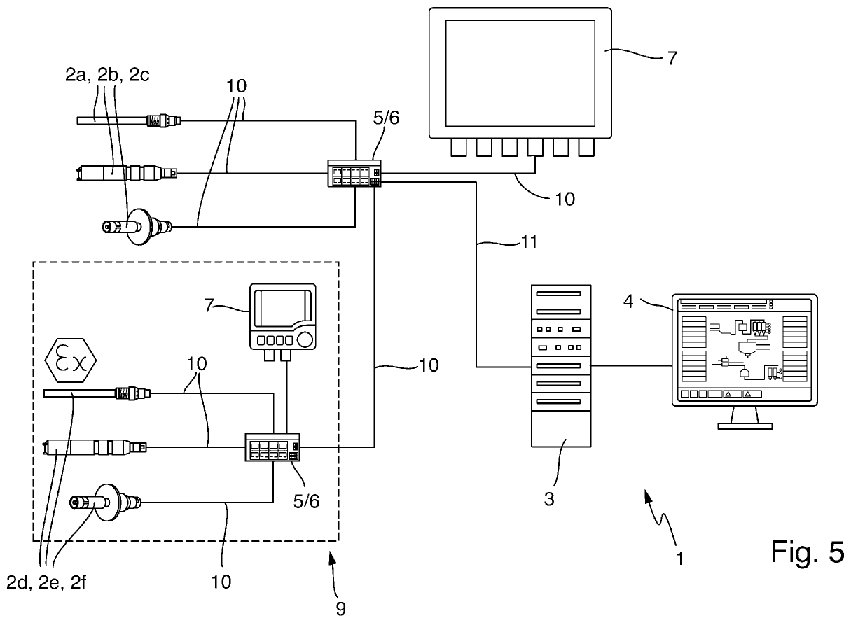

FIG. 5 shows an embodiment. In this case, three sensors 2a, 2b, 2c, or 2d, 2e, 2f are in each case located in the explosion-endangered area 9 or in the non-explosion-endangered area and are each connected to an intermediate unit 5, in this case configured as a switch 6, via the network-based protocol 10. A control panel 7 is optionally located on the switch 6 in the explosion-endangered area 9. The switch 6 in the explosion-endangered area 9 is connected to the switch 6 from the non-explosion-endangered area. A further control panel 7 is optionally connected to the switch in the explosion-endangered area 9. The further wiring and the protocol at the switch 6 of the non-explosion-endangered area is configured as shown above, i.e., for example, by Ethernet 10 to the control panel 7 and via a non-network-based protocol 11 to the higher-level unit 3.

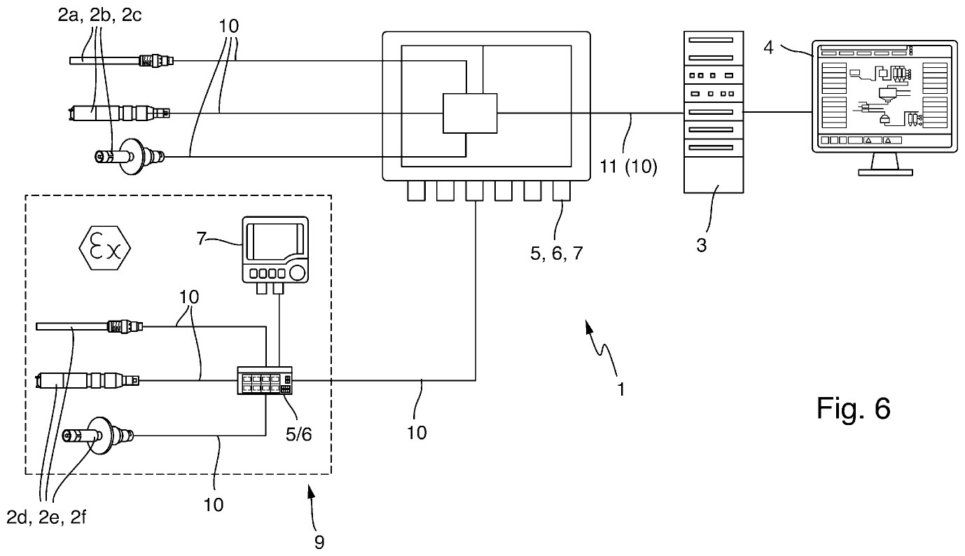

FIG. 6 shows an embodiment. This is similar to FIG. 5 with an explosion-endangered area 9 and a non-explosion-endangered area, in each case with three sensors 2a, 2b, 2c, or 2d, 2e, 2f. The sensors 2a, 2b, 2c from the non-explosion-endangered area are connected directly via the network-based protocol 10 to an intermediate unit 5, which is also configured as a control panel 7. The sensors 2d, 2e, 2f are first connected to an intermediate unit 5 via the network-based protocol 10 (as a switch 6) and then to the control panel 7 via the network-based protocol 10. The control panel 7 thus also serves as a switch 6. The higher-level unit 3 is connected to the control panel 7 via a non-network-based protocol 11 (HART, WirelessHART, Modbus, PROFIBUS, Foundation Fieldbus, IO-Link, Bluetooth, RFID) or via a network-based protocol 10 (Ethernet—“classic,” APL, or SPE). In this embodiment, the control panel 7 thus also serves as a gateway. The control panel 7 is thus used as a control panel for the sensors 2a-f. The control panel 7 can provide inputs/outputs. The higher-level unit 3 can access the sensors 2a-f directly via the control panel 7. The control panel 7 is logically also part of the network 10

Shown in FIG. 2 and FIG. 3, but in principle applicable to all embodiments, is a non-sensor unit 12. Said non-sensor unit is only shown symbolically. The non-sensor unit 12 is connected to the intermediate unit 5 via the network-based protocol 10 or directly to a sensor 2a-f.

The non-sensor unit 12 is configured, for example, as a cleaning unit. The cleaning unit communicates directly with a sensor, sensor 2c in FIG. 2 and FIG. 3. The sensor 2c can directly inform the cleaning unit 12 that cleaning is necessary. The cleaning can also be started manually via the control panel 7. There are also cleaning units 12 having an operator interface. All sensors 2a-f located in the network 10 can then be seen in said operator interface. The corresponding sensor 2c to be cleaned is then selected in the configuration. This is particularly advantageous if the cleaning unit is connected to a plurality of sensors.

The non-sensor unit 12 can also be configured as an actuator, valve, pump, switch, or motor controller. One application is mixing media, or closing a valve when a filter rupture is detected. This takes place in direct communication, without the influence of the higher-level unit 3.

The non-sensor unit 12 can also be configured as a fitting. The sensor 2a-f of the fitting then directly communicates that it is to be moved out of the medium. This is advantageous under certain conditions, for example if the medium is too hot or cold or if cleaning is necessary (see above).

Claimed is:

1. A network-based measuring system, comprising:
a first sensor;
at least one second sensor; and
at least one intermediate unit, wherein the first and/or second sensor are electrically connected to the intermediate unit via a connection,
wherein the first and second sensors are supplied with power via the connection and data is exchanged bidirectionally,
wherein the connection comprises a network-based protocol, in particular with TCP/IP protocol,
wherein the intermediate unit is connected to a higher-level unit,
wherein the first and second sensors exchange data with one another without knowledge of the higher-level unit.

2. The measuring system according to claim 1,
wherein the network-based protocol comprises the Ethernet Advanced Physical Layer as a physical layer.

3. The measuring system according to claim 1,
wherein the network-based protocol comprises a standard according to IEC 63171-7.

4. The measuring system according to claim 1,
wherein the network-based protocol is configured as a wireless protocol.

5. The measuring system according to claim 1,
wherein the first and/or second sensor comprises an external power supply.

6. The measuring system according to claim 1,
wherein the first and/or second sensor is an ion-sensitive sensor, in particular a pH sensor, conductivity sensor, turbidity sensor, temperature sensor, oxygen sensor, a sensor for measuring the absorption of electromagnetic waves in the medium, a sensor for measuring the concentration of metallic or non-metallic substances, a flow sensor, pressure sensor, or fill-level sensor.

7. The measuring system according to claim 1,
wherein the first and second sensors are configured independently.

8. The measuring system according to claim 7, comprising:
a control panel that is connected to a sensor or is connected to the intermediate unit or is part of the intermediate unit, and wherein the first and second sensors and the control panel exchange data with one another without knowledge of the higher-level unit.

9. The measuring system according to claim 1,
wherein the control panel is connected to the higher-level unit via a network-based protocol.

10. The measuring system according to claim 1,
wherein the control panel is connected to the higher-level unit via a non-network-based protocol.

11. The measuring system according to claim 1,
wherein the intermediate unit is configured as a switch.

12. The measuring system according to claim 1,
wherein the second sensor retrieves measurement data from the first sensor.

13. The measuring system according to claim 1, comprising:
a non-sensor unit that is connected to the network-based protocol.

14. The measuring system according to claim 1,
wherein the first sensor, the second sensor, the switch and/or the control panel are configured as explosion-proof devices.
